(19) United States
(12) Patent Application Publication
(10) Pub. No.: US 2018/0303288 A1
(43) Pub. Date: Oct. 25, 2018

(54) Coffee grinder

(71) Applicant: Mazzer Luigi S.p.A., Gardigiano di Scorzé (IT)

(72) Inventor: Giovanni Mazzer, Gardigiano di Scorzé (IT)

(21) Appl. No.: 15/768,587

(22) PCT Filed: Oct. 18, 2016
(86) PCT No.: PCT/IB2016/056252

§ 371 Date: Apr. 16, 2018

(30) Foreign Application Priority Data
Oct. 22, 2015 (IT) UB2015U086483

(51) Int. Cl. A47J 42/40; A47J 42/50; A47J 42/56

(52) U.S. Cl. CPC A47J 42/40; A47J 42/56; A47J 42/50

(57) ABSTRACT

A coffee bean grinder includes a base internally housing an electric motor and supporting a bell-shaped vessel for containing coffee beans, the bell-shaped vessel being provided lowerly with an exit mouth connected to a grinding chamber housing a grinder rigid with the electric motor shaft, the grinding chamber being provided lowerly with an exit hole, wherein the base is provided, in a position corresponding with the ground coffee exit hole, with a seat for sealed engagement with a container, which is completely closed except for an opening present in the upper surface, and of which the dimensions correspond substantially to the dimensions of the ground coffee exit hole hole, the opening facing the hole when the container is engaged in the seat.

The present invention relates to a coffee grinder.

Coffee grinders are known, comprising a base structure housing an electric motor of horizontal axis, the shaft of which is rigidly connected to a grinding device housed within a grinding chamber.

The grinding chamber communicates upperly with a transparent bell-shaped vessel containing the coffee to be ground, and is provided lowerly with a delivery conduit for the ground coffee.

Currently, to collect the ground coffee, an open bag is sometimes positioned on a base, while in other cases it is applied to the base structure by a spring clip.

Alternatively, small quantities of coffee are withdrawn for use in manual percolation systems, by collection in containers positioned under the delivery conduit and resting lowerly on a suitable support.

In both cases these grinders present the drawback of soiling the surrounding environment with coffee powder which escapes from the conduit.

The object of the invention is to eliminate these drawbacks by providing a grinder which not only enables the surrounding environment to be maintained clean, but at the same time enabling a quantity of coffee beans to be ground equivalent to the desired dose.

This object is attained according to the invention by a coffee grinder as described in claim 1.

The present invention is further clarified hereinafter with reference to the accompanying drawings, in which:

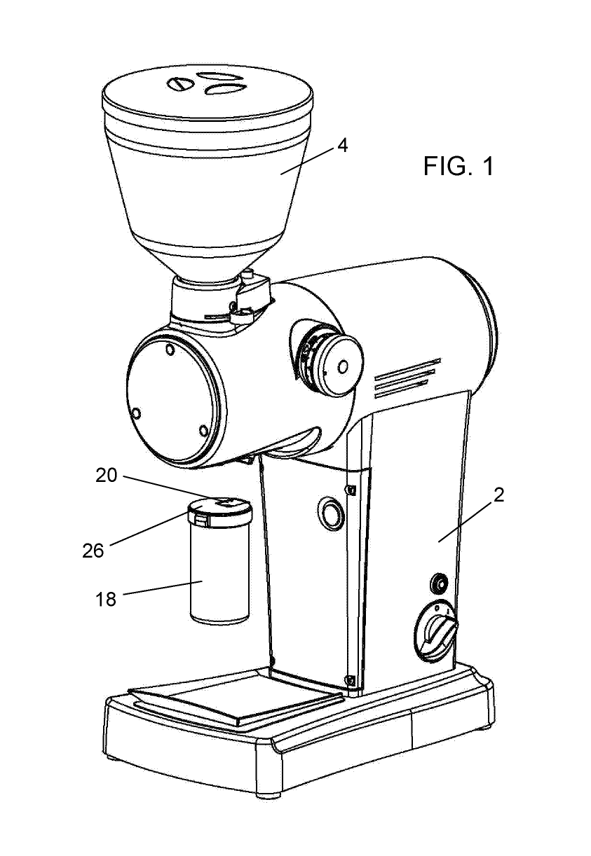

FIG. 1 is an exploded perspective view of a grinder according to the invention,

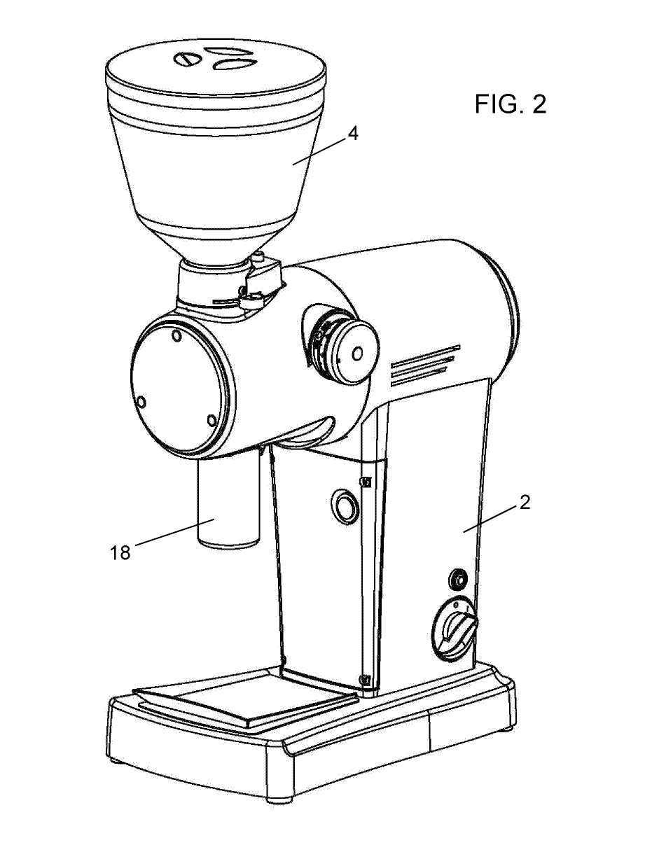

FIG. 2 is an assembled view thereof,

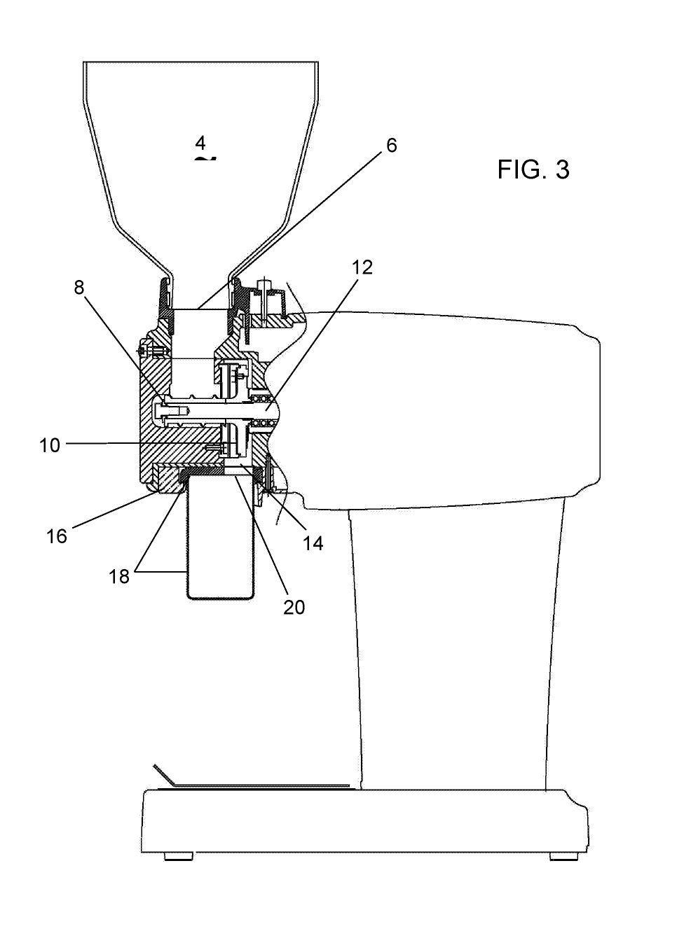

FIG. 3 is a longitudinal section therethrough, and

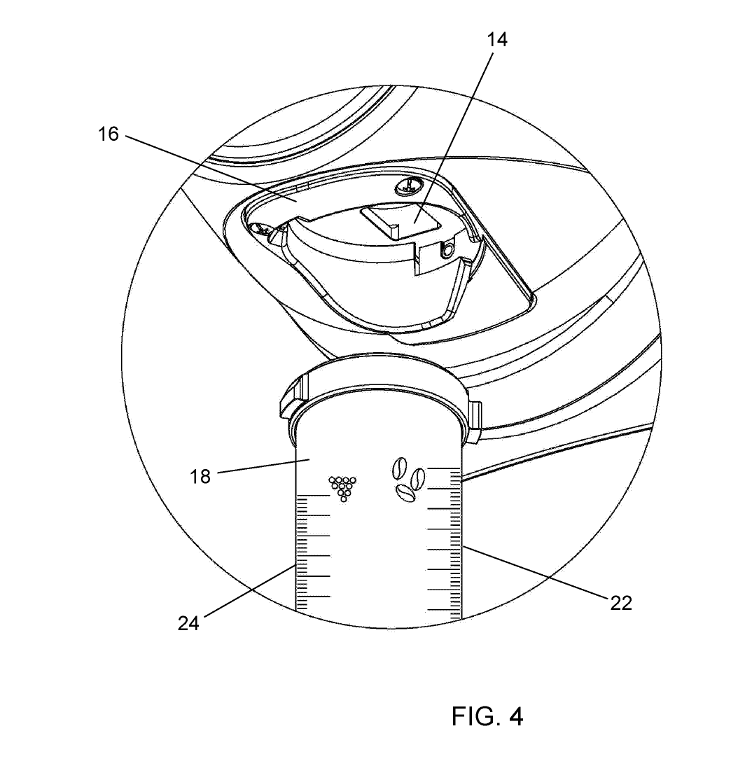

FIG. 4 is a detailed view of the connection between the container and the grinder.

As can be seen from the figures, the coffee grinder according to the invention comprises substantially a base 2 which houses internally an electric motor (not shown in the drawings) and which supports a transparent bell-shaped vessel 4 for containing the coffee beans.

The bell-shaped vessel is provided lowerly with an exit mouth 6 connected to a grinding chamber 8 housing a grinder 10 rigid with the electric motor shaft 12.

The grinding chamber 8 is provided lowerly with an exit hole 14 of substantially square shape.

In a position corresponding with the exit hole 14 of the grinding chamber 8, the base 2 is provided with a seat 16 for bayonet-engagement by a container 18, of preferably cylindrical shape, closed lowerly and upperly with the exception of an opening 20 present in the upper surface 26, and of which the dimensions correspond substantially to the dimensions of the hole 14.

Under normal operating conditions, when the container 18 is inserted in the seat 16, the opening 20 is faced by the hole 14.

The container can preferably be made of transparent material and present two measuring scales, one 22 for the coffee beans and one 24 for the ground coffee, as they occupy different volumes for equal weight.

The upper surface 26 of the container 18 is preferably made removable to enable easier filling, emptying or cleaning of the container.

The grinder according to the invention is used by applying the container 18 to the grinder and operating the electric motor such as to grind a quantity of beans which, once ground and transformed into powder, accumulates in the container 18 to the height corresponding to the desired quantity.

In other cases, the bartender loads the container with a certain quantity of coffee beans as far as the notch corresponding to the desired weight, pours it into the bell-shaped vessel, then fixes the container to the grinder, and grinds the entire coffee quantity contained in the bell-shaped vessel.

In a modified embodiment, not shown in the drawings, the seat 16 engages the upper edge of the container by magnetic attraction.

In a further embodiment, the engagement of the container 18 in the seat 16 disables a safety interlock which inhibits grinding.

The invention claimed is:

1.-6. (canceled)

7. A coffee bean grinder, comprising:
a base internally housing an electric motor and supporting a bell-shaped vessel for containing coffee beans, said bell-shaped vessel being provided lowerly with an exit mouth connected to a grinding chamber housing a grinder rigid with the electric motor shaft, said grinding chamber being provided lowerly with an exit hole,
wherein the base is provided, in a position corresponding with a ground coffee exit hole, with a seat for sealed engagement with a container, which is completely closed except for an opening present in an upper surface thereof, and which has dimensions that correspond substantially to dimensions of the ground coffee exit hole of the grinding chamber, said opening facing said hole when the container is engaged in the seat.

8. The coffee bean grinder as claimed in claim 7, wherein the container is made of a transparent material and has two measurement scales, one for the coffee beans and another one for the ground coffee.

9. The coffee bean grinder as claimed in claim 7, wherein the upper surface of the container is removable.

10. The coffee bean grinder as claimed in claim 7, wherein the seat bayonet-engages an upper edge of the container.

11. The coffee bean grinder as claimed in claim 7, wherein the seat engages an upper edge of the container by magnetic attraction.

12. The coffee bean grinder as claimed in claim 7, wherein the sealed engagement of the container in the seat disables a safety interlock which inhibits grinding.
